(19) United States
(12) Patent Application Publication
(10) Pub. No.: US 2009/0013071 A1
(43) Pub. Date: Jan. 8, 2009

(54) Provision Information Notification Apparatus, Provision Information Notification Method and Software Program

(75) Inventors: Kazuo Matoba, Akashi-shi (JP); Yasuji Takeuchi, Kobe-shi (JP); Tomoyuki Okamoto, Suita-shi (JP); Tomo Tsuboi, Itami-shi (JP); Yoshinori Sugahara, Kyoto-shi (JP); Satoshi Deishi, Ibaraki-shi (JP); Kagumi Moriwaki, Kawanishi-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/107,109

(22) Filed: Apr. 22, 2008

(30) Foreign Application Priority Data
Jul. 6, 2007 (JP) 2007-178673

(51) Int. Cl. G06F 15/173

(52) U.S. Cl. 709/224

(57) ABSTRACT

An apparatus and method is provided which enable a user using a plurality of terminals to obtain information in a convenient manner compared to conventional systems. An image forming apparatus includes a notification setting database 1K1 that stores, for each piece of RSS data designated by a user, individual notification setting data 8 indicating an attribute relating to a destination and a notification method designated by the user, an RSS data obtaining portion 105 that downloads and obtains the piece of the RSS data designated by the user from a Web server, and a notification control portion 106 that performs, every time when the piece of the RSS data designated by the user is obtained, a process for notifying a destination indicated in the individual notification setting data 8 of the piece of the RSS data by a notification method indicated therein.

This application is based on Japanese patent application No. 2007-178673 filed on Jul. 6, 2007, the contents of which are hereby incorporated by reference.

### BACKGROUND OF THE INVENTION

1. Field of the Invention

The present invention relates to an apparatus and method for notifying a user of information provided by a server such as a Web server.

2. Description of the Related Art

Improvement has recently been seen in CPU speed, a storage capacity of a memory, communication speed, and a resolution of a display panel in mobile terminals such as a cell phone, a PHS and a Personal Digital Assistant (PDA). This enables these mobile terminals to implement various application programs including a Web browser that could be implemented only by a personal computer in respect of performance.

Along with this, a user gets to use terminals for browsing information provided by a Web site selectively. The selective use of terminals is as follows: for example, in an office, information is browsed with a personal computer located in the office; during moving, information is browsed with a cell phone; and, at home, information is browsed with a personal computer located in the home.

Since various Web sites have recently been established, the types and amount of information provided to users are being increased.

There are proposed methods for a user to obtain information conveniently. According to the method described in Japanese unexamined patent publication No. 2006-139470, an information provision device generates list information showing a plurality of contents related to contents of a broadcast designated by a user based on user's designation. The list information is transmitted to a cell phone. The cell phone receives the list information of the contents related to a broadcast content viewed by the user and displays a list of the contents on a display part of the cell phone. The user designates the content from the list, so that the information provision device stores an RSS of the content.

According to the method described in Japanese unexamined patent publication No. 2005-332163, a detection object management server that constitutes a web page update detection system is placed on the Internet. The detection object management server manages a URL of data set as an object of update detection for each user of the web page update detection system and manages each user's contact information and a group to which each user belongs. An update detection server is placed in intranets connected to the Internet, accesses to a WWW server on the Intranet and WWW servers on the Internet according to the content of a database managed by the detection object management server and detects an update a state of a web page.

In some cases, a user using a plurality of terminals selectively uses the terminals not only depending on a location where the terminal is used but also depending on the purpose. Accordingly, it is not necessarily true that the user desires to browse information provided by a Web site at any terminal.

For example, a user may sometimes wish to browse large amount of information or information including a large image using a personal computer with a large display panel rather than using a mobile terminal with a small display panel. Further, a user may sometimes wish to browse information unrelated to work with a terminal for private use rather than a terminal in an office.

### SUMMARY

The present disclosure is directed to solve the problems pointed out above, and therefore, an object of an embodiment of the present invention is to improve the convenience for a user using a plurality of terminals to obtain information compared to conventional systems.

A provision information notification apparatus according to one aspect of the present invention is a provision information notification apparatus for obtaining one or more pieces of provision information designated by a user to notify the user, each of the pieces of the provision information being information provided by a server. The provision information notification apparatus includes a notification attribute storing portion that stores, for each of the pieces of the provision information, a notification attribute that is an attribute relating to notification of the piece of the provision information, the notification attribute including a destination and a notification method that are designated by the use, an obtaining portion that obtains the piece of the provision information via a communication line, and a notification portion that performs, every time when the piece of the provision information is obtained, a process for notifying the user of the piece of the provision information, the process being performed by sending the piece of the provision information to the destination included in the notification attribute of the piece of the provision information by the notification method included in the notification attribute of the piece of the provision information.

Preferably, the notification attribute of the piece of the provision information may include a type of character formatting to be applied to a character in the piece of the provision information, and the notification portion may change the piece of the provision information in accordance with the type included in the notification attribute of the piece of the provision information and sends the changed piece of the provision information.

Further, the notification attribute of the piece of the provision information may include a plurality of the destinations and a plurality of the notification methods and each of the destinations is a destination depending on one of periods and each of the notification methods is a notification method depending on one of the periods, and the notification portion may give notice of the piece of the provision information by sending the piece of the provision information to the destination depending on the period corresponding to time when the piece of the provision information is notified by the notification method depending on the period corresponding to the time.

The provision information notification apparatus may further include a detection portion that detects a current state of the user. The notification attribute of the piece of the provision information may include a plurality of the destinations and a plurality of the notification methods and each of the destinations is a destination depending on one of states and each of the notification methods is a notification method depending on one of the states, and the notification portion may give notice of the piece of the provision information by sending the piece of the provision information to the destination depending on the current state of the user detected by the detection portion by the notification method depending on the current state of the user detected by the detection portion.

The provision information notification apparatus may further include a printing portion that prints the piece of the provision information. When the notification method included in the notification attribute of the piece of the provision information is a method of electronic mail transmission, the notification portion may give notice of the piece of the provision information by sending an electronic mail message in which the piece of the provision information is described or to which the piece of the provision information is attached. When the notification method included in the notification attribute of the piece of the provision information is a method of message transmission with an instant messenger, the notification portion may give notice of the piece of the provision information by sending a message in which the piece of the provision information is described or to which the piece of the provision information is attached. When the notification method included in the notification attribute of the piece of the provision information is a method of provision of a printed material, the notification portion may give notice of the piece of the provision information by causing the printing portion to perform a process for printing the piece of the provision information on a sheet of paper when the user logs in the provision information notification apparatus, instead of by sending the piece of the provision information.

Further, the piece of the provision information may be described in an RSS format.

The provision information notification apparatus may further include a storage location storing portion that stores, for each of the pieces of the provision information, a location on a network where RSS data describing the piece of the provision information is stored. The obtaining portion may obtain, at each predetermined timing, the RSS data from the location where the RSS data is stored. When a plurality of pieces of the RSS data have been obtained from the same location at different timings, the notification portion may give notice of the piece of the provision information in which a piece of provision information described in RSS data obtained before is removed from another piece of provision information described in RSS data obtained recently.

The structure described above enables a user using a plurality of terminals to select a terminal for receiving information provided by a Web server or others on information basis. Thus, information can be obtained in a convenient manner compared to conventional systems.

These and other characteristics and objects of the present invention will become more apparent by the following descriptions of preferred embodiments with reference to drawings.

### BRIEF DESCRIPTION OF THE DRAWINGS

FIG. 1 is a diagram showing an example of a hardware configuration of an image forming apparatus.

FIG. 2 is a diagram showing an example of a functional configuration of an image forming apparatus.

FIG. 3 is a diagram showing an example of a connection relationship between an image forming apparatus and other devices.

FIG. 4 is a diagram showing an example of RSS data.

FIG. 5 is a diagram showing an example of a list of articles reproduced based on RSS data.

FIG. 6 is a diagram showing an example of destination setting data and individual notification setting data.

FIG. 7 is a flowchart showing an example of a flow of receiving an attribute of notification on a setting screen.

FIG. 8 is a diagram showing an example of a setting screen.

FIG. 9 is a diagram showing an example of individual notification setting data including a time condition.

FIG. 10 is a diagram showing an example of individual notification setting data including a condition of a user state.

FIG. 11 is a flowchart showing an example of the overall process flow in an image forming apparatus.

FIG. 12 is a flowchart showing an example of the overall process flow in an image forming apparatus.

FIG. 13 is a flowchart showing an example of a flow of RSS data processing.

FIG. 14 is a flowchart showing an example of a flow of a location confirmation process.

FIG. 15 is a flowchart showing an example of a flow of a one-touch registration process.

### DESCRIPTION OF THE PREFERRED EMBODIMENTS

An image forming apparatus 1 is one example of a provision information notification apparatus according to an embodiment of the present invention. It is an apparatus in which various functions including a copier function, a scanner function, a fax function, a document server function (so-called box function) and a network printing function (so-called PC print function) are integrated. In general, the image forming apparatus 1 is sometimes called a Multi Function Peripheral (MFP).

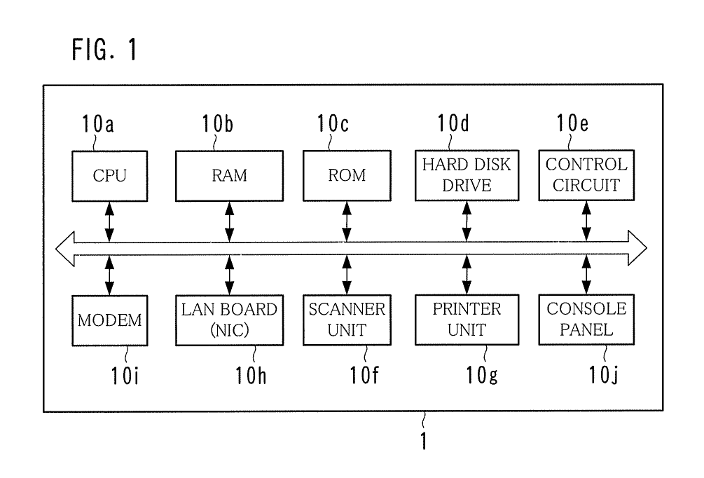

Referring to FIG. 1, the image forming apparatus 1 includes a CPU 10a, a RAM 10b, a ROM 10c, a hard disk drive 10d, a control circuit 10e, a scanner unit 10f, a printer unit 10g, a LAN board 10h, a modem 10i and a console panel 10j.

The control circuit 10e is a circuit for controlling the hard disk drive 10d, the scanner unit 10f, the printer unit log, the LAN board 10h, the modem 10i, the console panel 10j and others.

The scanner unit 10f serves to optically capture an image of a document such as text, mathematical formulae, symbols, photographs, diagrams or illustrations depicted on a sheet of paper, and to create image data.

The printer unit 10g serves to print an image on a sheet of paper based on image data that is obtained with the scanner unit 10f or image data sent from a personal computer, a fax terminal or others.

The LAN board 10h is a Network Interface Card (NIC) for performing communication with other device using a protocol such as TCP/IP. The modem 10i performs communication with a fax terminal using a fax protocol through a public line.

The console panel 10j is a touch panel. It displays a screen for providing messages or instructions to a user, a screen for the user to enter desired types of processing and processing conditions, and a screen indicating results of processes executed by the CPU 10a, for example. Also, the user can give a command to the image forming apparatus 1, or designate processing conditions, by touching a predetermined position of the console panel 10j. Thus, the console panel 10j serves as a user interface for the user who operates the image forming apparatus 1.

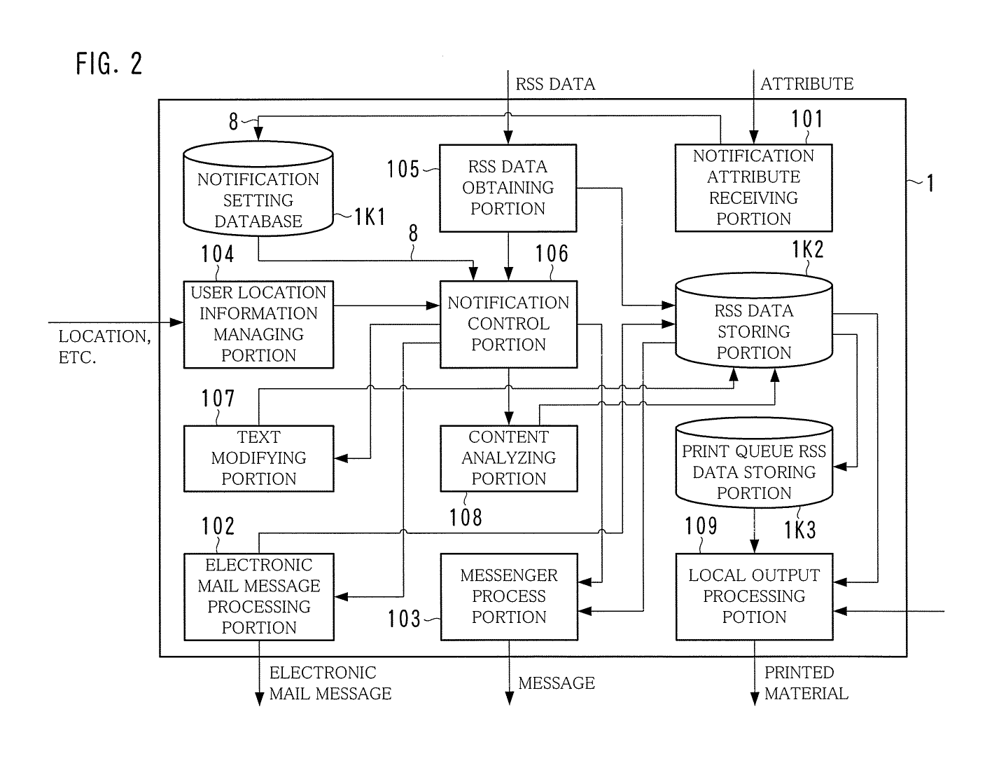

Referring to FIG. 2, on the ROM 10c or the hard disk drive 10d are stored programs and data for implementing portions such as a notification attribute receiving portion 101, an electronic mail message processing portion 102, a messenger process portion 103, a user location information managing portion 104, an RSS data obtaining portion 105, a notification control portion 106, a text modifying portion 107, a content analyzing portion 108, a local output processing potion 109, a notification setting database 1K1, an RSS data storing portion 1K2 and a print queue RSS data storing portion 1K3.

These programs and data are read out to the RAM 10b when necessary, and the CPU 10a executes the programs. A part of or all the functions shown in FIG. 2 may be implemented with a circuit such as the control circuit 10e.

Each portion shown in FIG. 2 makes it possible to notify a destination desired by a user of information on an article (item) newly added to a Web site on the Internet or on an updated article (item) therein. This mechanism will be detailed later.

The CPU 10a also executes other programs appropriately to control the entire image forming apparatus 1.

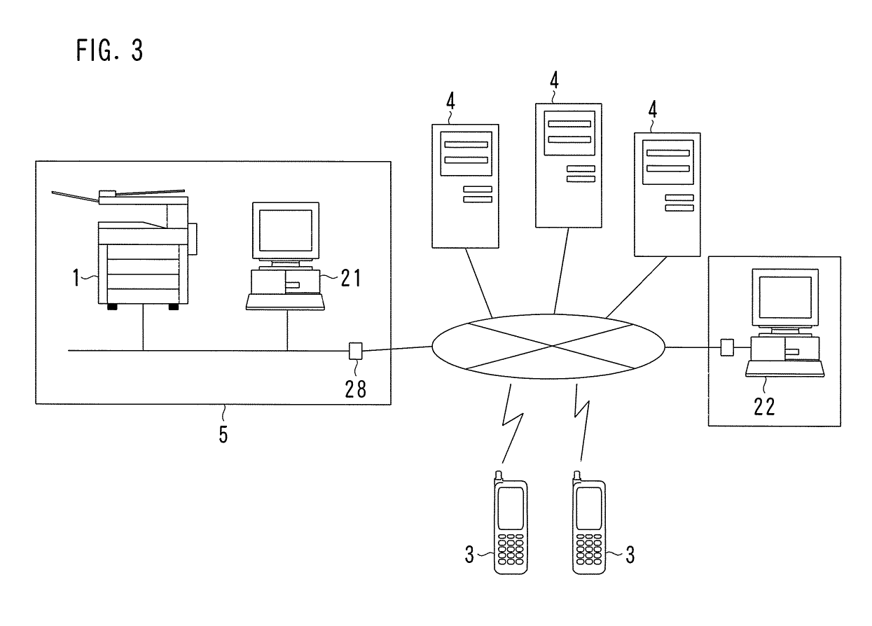

As shown in FIG. 3, the image forming apparatus 1 is located in an intranet 5 of an organization such as government and corporate offices and a school. Besides the image forming apparatus 1, a terminal 21, a router 28 and others are also located in the intranet 5.

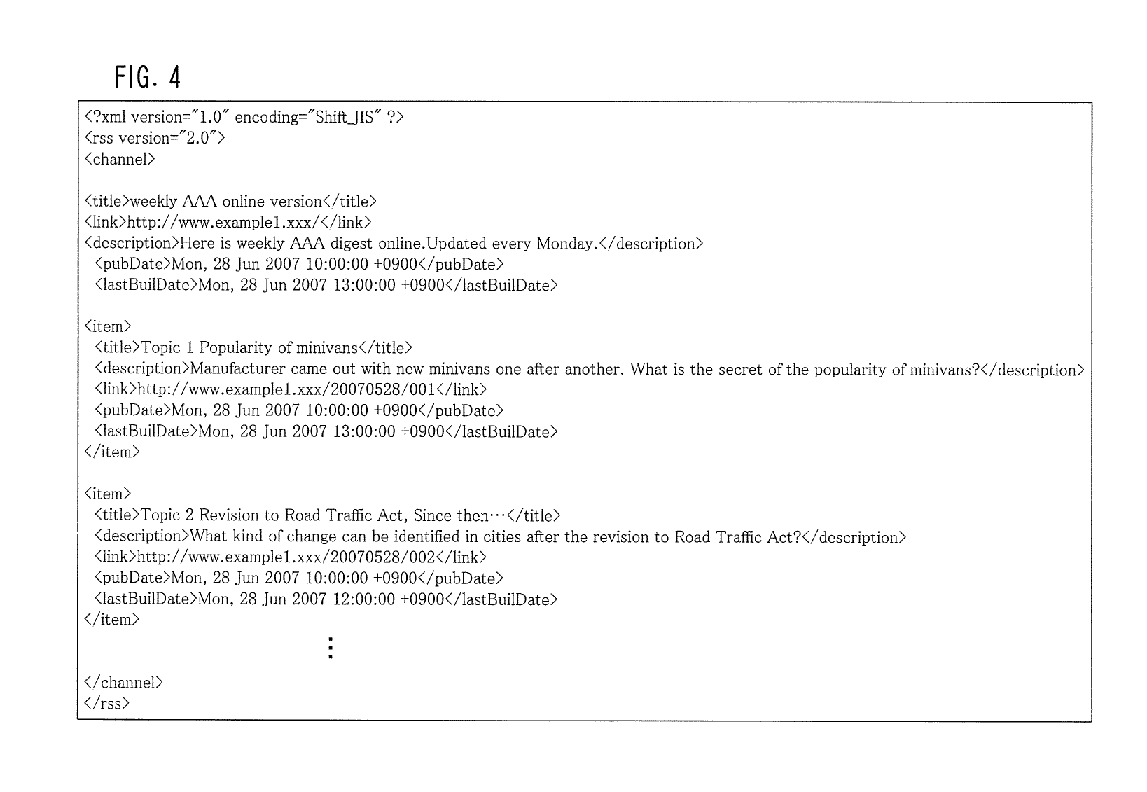

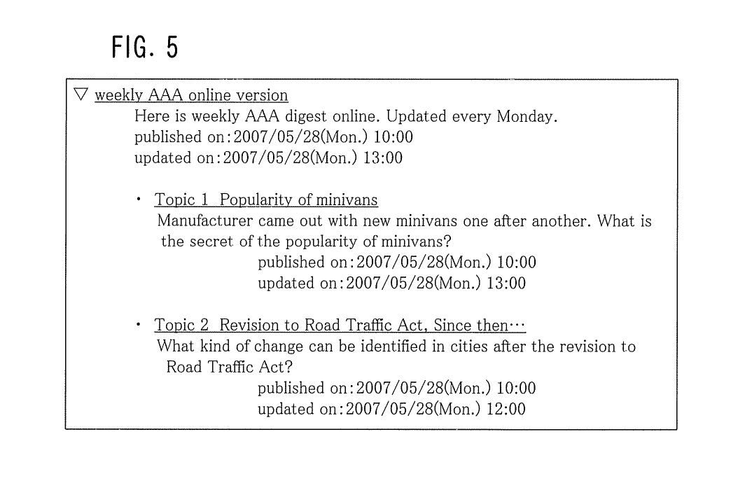

The terminal 21 is a client for the image forming apparatus 1 and is a device to use the scanner function, the fax function, the box function, the PC print function, and other function of the image forming apparatus 1. Further, on the terminal 21 is installed at least one of an electronic mail application program for creating and sending/receiving an electronic mail message and an instant messenger (hereinafter, referred to as an “IM”) application program for using an IM service. Besides, on the terminal 21 is installed an application program (so-called RSS reader) for displaying a list of a new article or an updated article as shown in FIG. 5 based on RSS data illustrated in FIG. 4. A personal computer, a workstation, a PDA or the like is used as the terminal 21.

The router 28 serves to connect the intranet 5 to an external network such as the Internet. This enables the image forming apparatus 1 and the terminal 21 to perform communication with a device outside the intranet 5. The image forming apparatus 1 and the terminal 21 can perform communication with, for example, a Web server 4 connected to the Internet, a cell phone terminal 3 connected to a cell phone network or a terminal 22 within a different intranet connected to the Internet.

The cell phone terminal 3 is a terminal for cell phone communication that is provided with at least one of an electronic mail application program and an IM application program. Besides, the cell phone terminal 3 is provided with an RSS reader.

As described above, the terminal 22 is a terminal provided in an intranet different from the intranet 5. As with the terminal 21, at least one of an electronic mail application program and an IM application program is installed on the terminal 22. Besides, an RSS reader is installed on the terminal 22.

The Web server 4 provides a terminal connected to the Internet with a Web site made up of one or more Web pages. The Web server 4 also provides the terminal connected to the Internet with RSS data. The RSS data is data in which, for each article in the Web site, information on a title (heading), a summary, a URL, published date and time, last updated date and time, and others is described in an RSS format.

Note that the RSS format is different depending on the version. The full name of the RSS is also different depending on the version. The full name is “RDF Site Summary”, “Rich Site Summary” or “Really Simple Syndication”. The image forming apparatus 1, the terminals 21 and 22, the cell phone terminal 3 and the Web server 4 can support all of the versions of SSL.

The following is a detailed description of process contents of each portion of the image forming apparatus 1 shown in FIG. 2, the terminal 21, the terminal 22, the cell phone terminal 3 and the Web server 4.

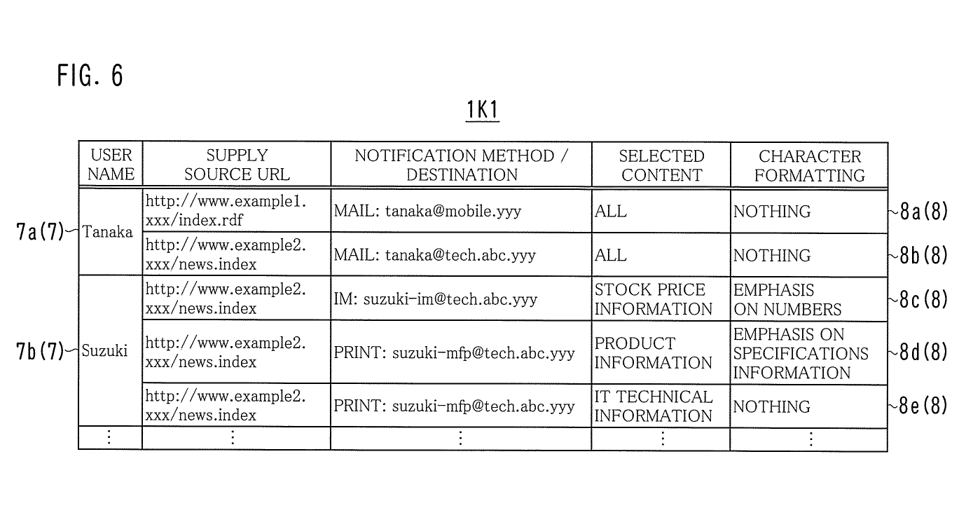

The notification setting database 1K1 shown in FIG. 2 stores destination setting data 7 as shown in FIG. 6 for each user.

The destination setting data 7 includes data indicating a user name of a user having the destination setting data 7 and individual notification setting data 8. The destination setting data 7 of one user can include a plurality of pieces of individual notification setting data 8.

The individual notification setting data 8 is prepared for each attribute of notification of RSS data. The attribute is desired by the corresponding user and includes a notification content, a notification method and a destination.

In the case where it is desired that, for example, RSS data for a certain Web site is notified to a personal computer and RSS data for a different Web site is notified to a cell phone terminal, two pieces of individual notification setting data 8 such as individual notification setting data 8a and individual notification setting data 8b are prepared accordingly.

Alternatively, even in the case of RSS data for the same Web site, when it is desired that an article relating to stock price information is notified to a personal computer via IM with numbers emphasized, an article relating to product information is notified by causing the image forming apparatus 1 to perform printing with words/phrases about specifications emphasized, and an article relating to IT technical information is notified by causing the image forming apparatus 1 to perform printing with nothing emphasized, three pieces of individual notification setting data 8 such as individual notification setting data 8c, individual notification setting data 8d and individual notification setting data 8e are prepared accordingly.

In the individual notification setting data 8, “supply source URL” indicates a URL of RSS data desired by a user, i.e., a location of the RSS data on the Internet.

“Notification method/destination” indicates a destination (transmission destination) and a notification method of the RSS data. The right side of the colon (:) shows the destination and the left side thereof shows the notification method. In the case where, however, the notification method is printing (PRINT) with the image forming apparatus 1, the destination shows information for identifying the user (for example, an electronic mail address that the user uses to receive electronic mail messages with the image forming apparatus 1).

“Selected content” shows what kind (genre) of article should be notified (sent) in the form of RSS data. “Character formatting” shows what type of character formatting should be applied to which word or letter in text included in RSS data.

As described later, RSS data is notified based on each piece of the individual notification setting data 8 included in the destination setting data 7. Accordingly, the individual notification setting data 8 indicates conditions for notification of RSS data.

Referring back to FIG. 2, the electronic mail message processing portion 102 performs a process regarding transmission and reception of electronic mail messages. In particular, as described later, the electronic mail message processing portion 102 performs a process for receiving an electronic mail message indicating an attribute of notification of RSS data desired by a user and a process for sending an electronic mail message in which RSS data is described in the body or to which RSS data is attached as an attachment file.

The messenger process portion 103 performs a process of an IM service. In particular, as described later, the messenger process portion 103 performs a process for sending a message in which RSS data is described in the body or to which RSS data is attached as an attachment file.

The notification attribute receiving portion 101 performs a process for accepting an attribute of notification of RSS data newly desired by a user. The following is a description of the procedure of this acceptance process.

A user, in advance, finds a Web site with respect to which the user desires to know new registration of an article or update of an article, and checks a URL of RSS data for the Web site.

The user operates his/her terminal 21, terminal 22, cell phone terminal 3 or the like to create an electronic mail message in which a URL, notification method and destination of the RSS data and a user name of the user are described in the body. If the user desires only data of a particular genre among the RSS data, then the genre is also described in the body of the electronic mail message. If the user desires to apply character formatting to a particular word or letter, then that is described in the body of the electronic mail message.

After that, the user gives the electronic mail message a predetermined title and causes his/her terminal 21, terminal 22, cell phone terminal 3 or the like to send the electronic mail message to the image forming apparatus 1.

With the image forming apparatus 1, when the electronic mail message processing portion 102 receives the electronic mail message, the title thereof is referred to. After that, when the electronic mail message processing portion 102 determines that the electronic mail message is related to an attribute of notification of RSS data newly desired by the user, it gives the electronic mail message to the notification attribute receiving portion 101.

Responding to this, the notification attribute receiving portion 101 checks whether there is no problem with the details described in the body of the electronic mail message. The notification attribute receiving portion 101 checks, for example, whether or not the URL and the user name is valid, and others. If there is no problem, then the notification attribute receiving portion 101 accepts the electronic mail message. Then, the notification attribute receiving portion 101 generates individual notification setting data 8 in which the URL, notification method, destination, genre, word to which character formatting should be applied and character formatting method (for example, emphasis, underline or deletion) described in the body of the electronic mail message are respectively shown in fields of “supply source URL”, “notification method/destination”, “selected content” and “character formatting”. After that, the individual notification setting data 8 thus generated is registered in destination setting data 7 corresponding to the user name described in the body of the electronic mail message.

If there is no destination setting data 7 corresponding to the user name, then it is preferable that such destination setting data 7 is newly generated.

In some cases, the same notification method and destination are set in a plurality of pieces of the individual notification setting data 8 of the same user. So, default values of a notification method and a destination may be set in advance for each user. In the case where a user has not described a notification method and a destination in an electronic mail message, individual notification setting data 8 indicating a default notification method and a default destination may be generated and registered in the destination setting data 7 corresponding to the user.

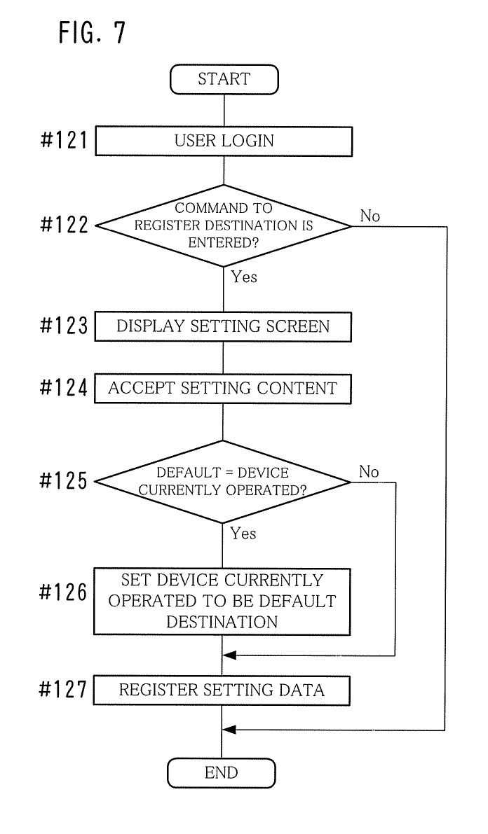

The notification attribute receiving portion 101 causes the console panel 10j or a Web browser of a terminal or the like to display a screen for setting and accepts an attribute of notification of RSS data newly desired by a user through the screen. The following is a description of an example of the procedures of this process with reference to the flowchart shown in FIG. 7.

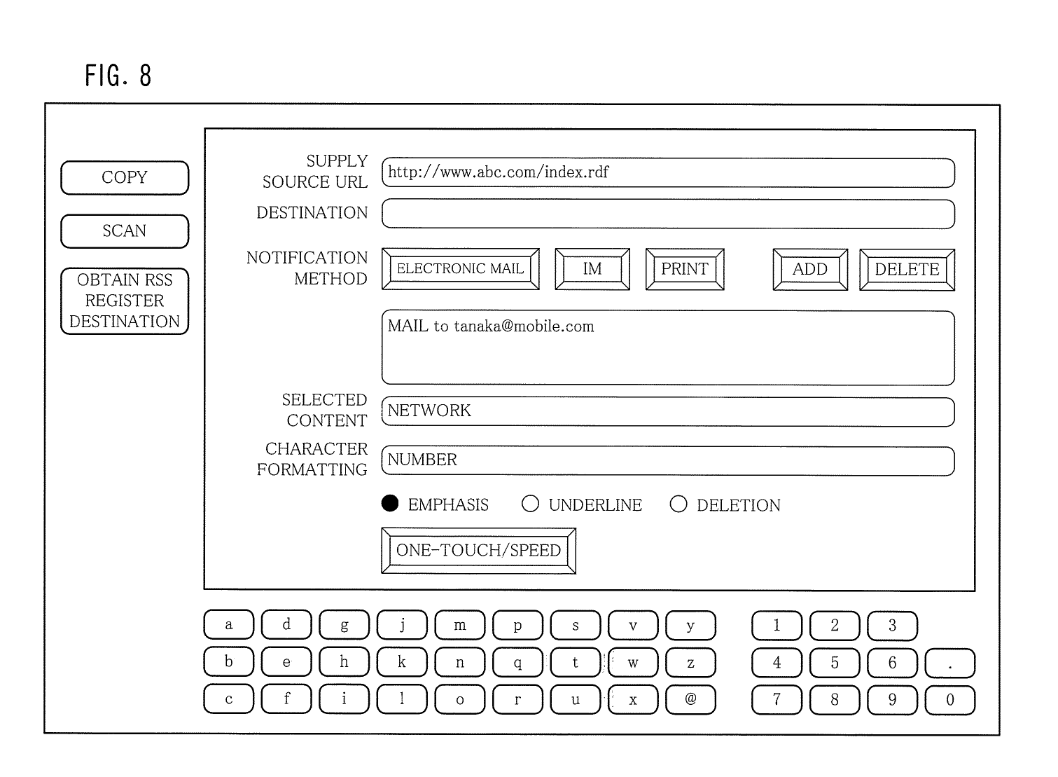

When a user logs in the image forming apparatus 1 (#121 in FIG. 7) and enters a command to register an attribute of notification (Yes in #122), the notification attribute receiving portion 101 displays a screen for setting as shown in FIG. 8 (#123). In the case where a user operates a terminal such as the terminal 21, the terminal 22 or the cell phone terminal 3 to log in the image forming apparatus 1 remotely, such a screen is displayed on the terminal. In the case where a user operates the console panel 10j to log in the image forming apparatus 1, such a screen is displayed on the console panel 10j.

On the screen for setting as shown in FIG. 8, the user designates an attribute of notification of desired RSS data. Items to be designated are the same as the case of the electronic mail message described earlier. In the case where a notification method and a destination can be default values, it is desirable that a textbox named “destination” is in blank and no buttons of “electronic mail message”, “IM” and “print” included in “notification method” are selected.

The notification attribute receiving portion 101 accepts the designated content (#124), generates individual notification setting data 8 indicating the content and registers the same in the destination setting data 7 of the user (#127).

In the case where, however, no designation is made in the notification method and the destination, the notification attribute receiving portion 101 assumes that default values are designated as the notification method and the destination for the user, generates individual notification setting data 8, and registers the same.

Alternatively, in the case where no designation is made in the notification method and the destination, and a notification method and a destination suitable for a device currently being operated are set as default values for the user (Yes in #125), individual notification setting data 8 indicating the device as the destination and a preferred notification method for the device is generated and registered (#126 and #127).

For example, in the case where a device currently being operated is the terminal 21 and an application program for electronic mail is installed on the terminal 21, individual notification setting data 8 is generated and registered that shows, as the notification method, an electronic mail message (MAIL) and shows, as the destination, an electronic mail address for the user to receive electronic mail messages at the terminal 21. Alternatively, in the case where a device currently being operated is the image forming apparatus 1, individual notification setting data 8 is generated and registered that shows, as the notification method, printing (PRINT) and shows, as the destination, an electronic mail address for the user to receive electronic mail messages at the image forming apparatus 1.

A description as to how to use a “one-touch/speed” button (see FIG. 8) will be provided later.

Referring back to FIG. 2, the user location information managing portion 104 detects a state of each user such as the user's location (for example, whether or not a user logs in the intranet 5 or where a user is). Then, the user location information managing portion 104 stores and manages information showing the latest location of each user thus detected. The detection of the user state can be performed, for example, in the following manner.

An inquiry as to whether or not a user to be detected logs in is made to the terminal 21, the terminal 22 or the cell phone terminal 3 by sending a packet for confirmation thereto. In the case where an authentication server is located in the intranet 5 and the authentication server performs a process regarding login centrally, an inquiry as to whether or not a user to be detected logs in the intranet 5 currently is made to the authentication server.

In the case where a system for managing a schedule (a groupware server, for example) is located in the intranet 5, an inquiry as to the current location of the user is made to the system.

In the case where the cell phone terminal 3 of the user can be used as an extension telephone in a facility of an organization and can be used as a cell phone terminal outside the facility, an inquiry as to whether or not the cell phone terminal 3 of the user currently functions as an extension telephone is made to a telephone switchboard in the intranet 5. It is determined that the user is in the organization facility when it functions as an extension telephone, and that the user is outside the organization facility when it does not function as an extension telephone.

In the case where the cell phone terminal 3 of the user has a Global Positioning System (GPS) function, the detection is made by obtaining positional information indicating the current position from the cell phone terminal 3.

In the case where an organization has a system for managing a working hour, an inquiry as to whether the user is at business or returns home is made to the system. Thereby, it is detected whether or not the user is in a facility of the organization. In the case where the organization has a management system for entry into/exit from the facility of the organization, an inquiry is made to the system, so that a user's location can be detected.

The RSS data obtaining portion 105 downloads and obtains RSS data indicated in “supply source URL” of each piece of individual notification setting data 8 included in destination setting data 7 of each user stored in the notification setting database 1K1. For example, if a URL such as “http://www.example1.xxx/index.rdf” is indicated in the individual notification setting data 8, then the RSS data obtaining portion 105 accesses to a Web server 4 belonging to the domain of “example1.xxx” and having the server name of “www” and downloads RSS data (an RSS file) having the file name of “index.rdf”.

The RSS data obtained by the RSS data obtaining portion 105 is associated with information on, for example, a URL of a supply source from which the RSS data is obtained and the date and time when the RSS data is obtained, and is stored in the RSS data storing portion 1K2. Further, in the RSS data storing portion 1K2, an open flag indicating whether or not the details were disclosed to a user is associated on an RSS data basis. The initial value of the open flag is “0” meaning that the details are not disclosed yet.

The text modifying portion 107 performs a process for applying character formatting to a character string in RSS data that is obtained by the RSS data obtaining portion 105 based on a supply source URL of individual notification setting data 8. The character string is a part or the whole of a title or summary of an article. Specifically, the RSS data is so updated that character formatting is applied to a word or a letter in accordance with the item of “character formatting” of the individual notification setting data 8.

For example, in the case where the individual notification setting data 8 shows that a number should be emphasized, a number is searched from character strings included in the RSS data. Then, a tag for bold type or a tag for increasing the font size is inserted in order to make the number stand out. In this way, the RSS data is updated.

In the case where the individual notification setting data 8 shows that specifications information should be emphasized, a word regarding specifications, e.g., a word meaning a CPU, a RAM, a hard disk drive or an OS is searched from character strings included in the RSS data. Then, a tag is inserted so as to make such a word stand out, so that the RSS data is updated. These words may be registered in a database in advance.

The content analyzing portion 108 analyzes RSS data obtained by the RSS data obtaining portion 105 based on a supply source URL of individual notification setting data 8, selects, from among the RSS data, an article (ITEM) relating to a genre indicated in the selected content of the individual notification setting data 8, reserves the selected article and deletes articles other than the selected article. In short, the content analyzing portion 108 divides the RSS data.

For example, in the case where the genre of “stock price information” is indicated in individual notification setting data 8, an article (ITEM) relating to stock price is selected from among the RSS data and is reserved, and articles other than the selected article are deleted.

The notification control portion 106 controls the electronic mail message processing portion 102, the messenger process portion 103, the RSS data obtaining portion 105, the text modifying portion 107, the content analyzing portion 108, the print queue RSS data storing portion 1K3 and others according to the procedure described below. Thereby, a part or the whole of RSS data transmitted from the Web server 4 is notified to a user based on the individual notification setting data 8.

The RSS data obtaining portion 105 is controlled to perform a process for obtaining RSS data corresponding to a URL indicated in “supply source URL” of individual notification setting data 8. The content analyzing portion 108 is controlled to perform a process for selecting an article of a genre indicated in “selected content” of the individual notification setting data 8 from among the obtained RSS data. Note, however, that the selection process is not necessary as long as “all” is indicated in “selected content”.

The text modifying portion 107 is controlled to perform a process for applying character formatting to a word or the like in the RSS data that is obtained and is subjected to the selection process as needed in accordance with details indicated in “character formatting” of the individual notification setting data 8. Note, however, that the character formatting is not necessary as long as “nothing” is indicated in “character formatting”.

The electronic mail message processing portion 102 or the messenger process portion 103 is controlled to perform a process for notifying (sending to) a user of the RSS data that is subjected to the selection process or the character formatting as needed in accordance with details indicated in “notification method/destination” of the individual notification setting data 8. In the case where the notification method indicated in “notification method/destination” is “MAIL”, i.e., an electronic mail message, the electronic mail message processing portion 102 is caused to perform a process for sending, to a destination indicated in “notification method/destination”, an electronic mail message in which the RSS data is described in the body or to which the RSS data is attached as an attachment file. In the case where the notification method is IM, the messenger process portion 103 is caused to perform a process for sending, to a destination indicated in “notification method/destination”, a message in which the RSS data is described in the body or to which the RSS data is attached as an attachment file.

In the case where the notification method is “PRINT”, i.e., printing, the print queue RSS data storing portion 1K3 is controlled to store the RSS data that is subjected to the selection process or the character formatting as needed in association with a user name of a user relating to the individual notification setting data 8. As described later, the RSS data is used for printing a list of articles when the user will log in the image forming apparatus 1 next time.

Upon the receipt of an electronic mail message or a message, the terminal 21, the terminal 22 or the cell phone terminal 3 uses the RSS reader to display a list of articles indicated in RSS data described in or attached to the electronic mail message or the message. Then, the terminal 21, the terminal 22 or the cell phone terminal 3 informs the image forming apparatus 1 to the effect that the electronic mail message or the message was opened and the details of the RSS data were disclosed to a user.

When the image forming apparatus 1 accepts the information, the value of an open flag corresponding to the RSS data stored in the RSS data storing portion 1K2 is updated to “1” meaning that the details of the RSS data were disclosed to a user.

When a user logs in the image forming apparatus 1, in the case where the print queue RSS data storing portion 1K3 stores RSS data associated with a user name of the user, the local output processing potion 109 causes the printer unit 10g to perform a process for printing a list of articles indicated in the RSS data on a sheet of paper as shown in FIG. 5. A printing process may be performed in response to the receipt of printing instructions made by the user.

After the printing process, the RSS data is deleted from the print queue RSS data storing portion 1K3. In addition, the value of an open flag corresponding to RSS data that is stored in the RSS data storing portion 1K2 and is the same as the deleted RSS data is updated to “1”.

When a user logs in the image forming apparatus 1, in the case where the RSS data storing portion 1K2 stores RSS data that is associated with the user and to which an open flag having a value of “0” corresponds, the local output processing potion 109 displays a screen for informing that unconfirmed RSS data is present. Then, when the user designates any RSS data and enters printing instructions, the local output processing potion 109 prints a list of articles indicated in the RSS data on a sheet of paper as shown in FIG. 5.

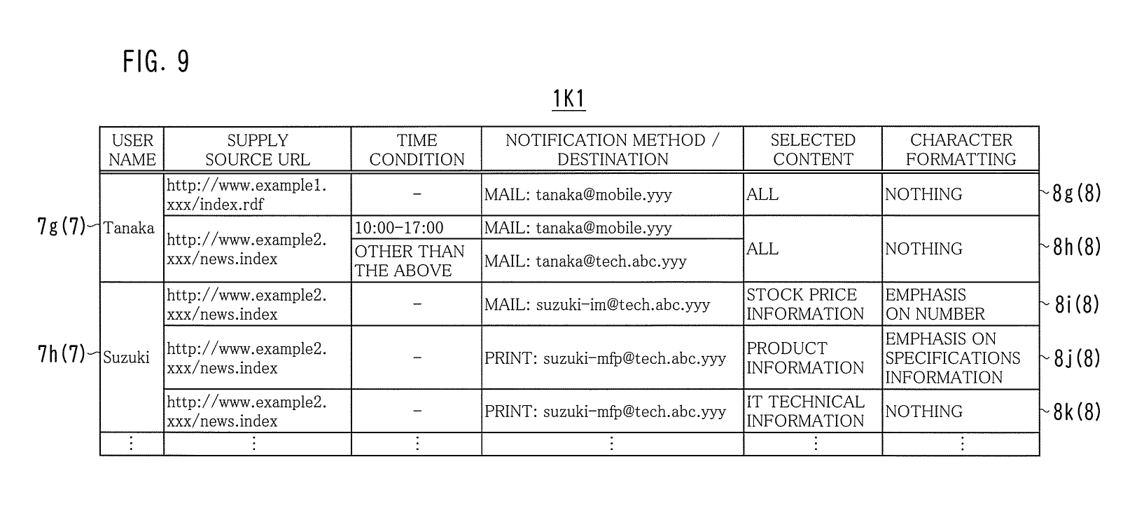

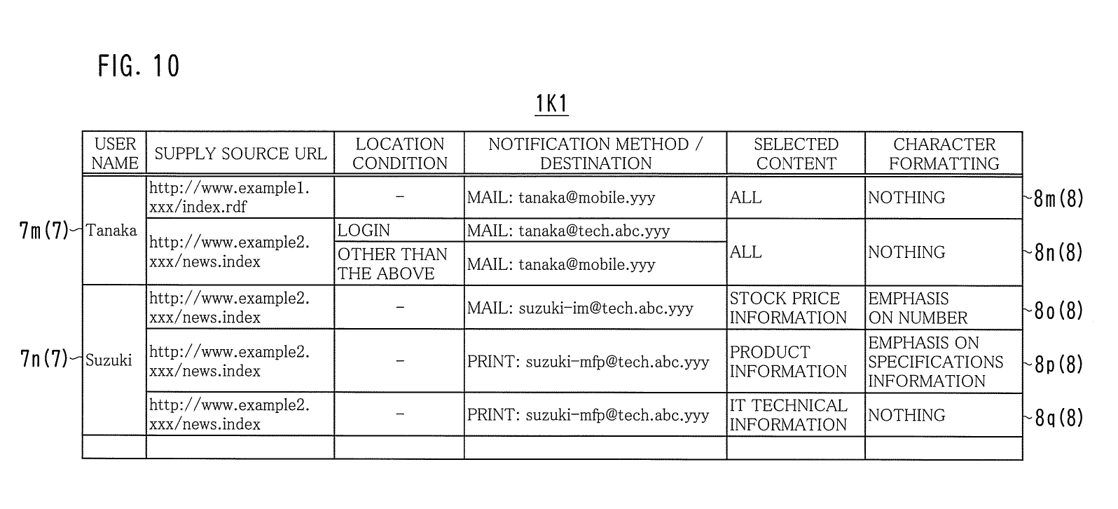

FIG. 9 is a diagram showing an example of individual notification setting data 8 including a time condition, and FIG. 10 is a diagram showing an example of individual notification setting data 8 including a condition of a user state.

A configuration is possible in which a notification method or a destination of RSS data can be set in individual notification setting data 8 depending on the time or a user's location.

As illustrated in individual notification setting data 8h in FIG. 9, for example, a setting is possible in which notification methods or destinations of RSS data are different depending on the time, e.g., a day of the week or a time slot.

Alternatively, as illustrated in individual notification setting data 8n in FIG. 10, for example, a setting is possible in which notification methods or destinations of RSS data are different depending on a state such as the current location of a user. The state is, for example, whether or not the user is logging in the intranet 5 or the image forming apparatus 1, whether or not the user is on duty, or the current location of the user.

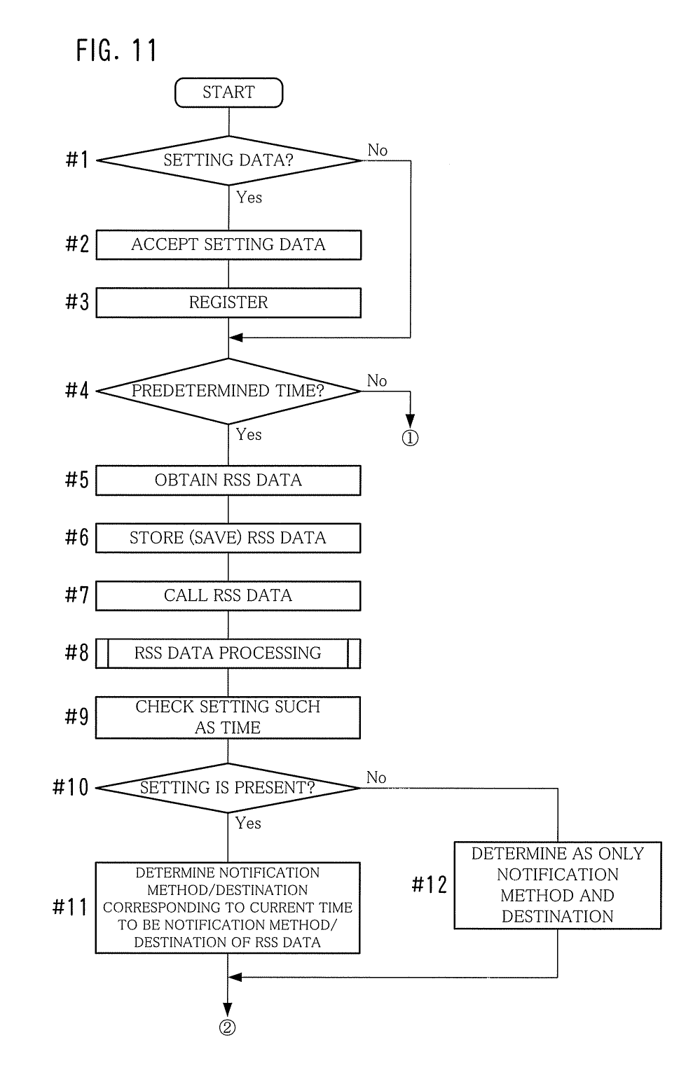

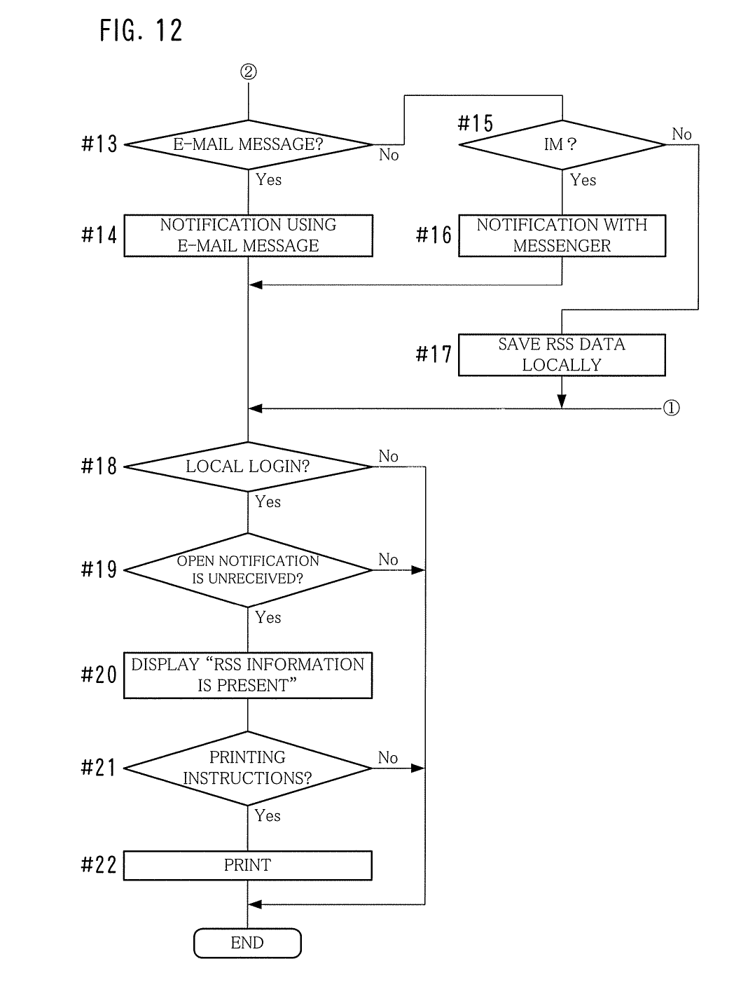

Here, a description is provided of the case where RSS data is notified to a user X with reference to the flowcharts shown in FIGS. 11 and 12.

The user X sends, in advance, to the image forming apparatus 1 an electronic mail message for setting in which an attribute including a URL, notification method and destination of desired RSS data, a genre of a necessary article and necessary character formatting are described.

When receiving the electronic mail message for setting (Yes in #1 in FIG. 11), the image forming apparatus 1 accepts the same (#2), newly generates individual notification setting data 8 and adds the generated individual notification setting data 8 to destination setting data 7 of the user X for registration (#3).

At predetermined time (Yes in #4), the image forming apparatus 1 downloads and obtains RSS data from the Web server 4 based on the individual notification setting data 8 of the user X (#5), and stores the RSS data in the RSS data storing portion 1K2 (#6).

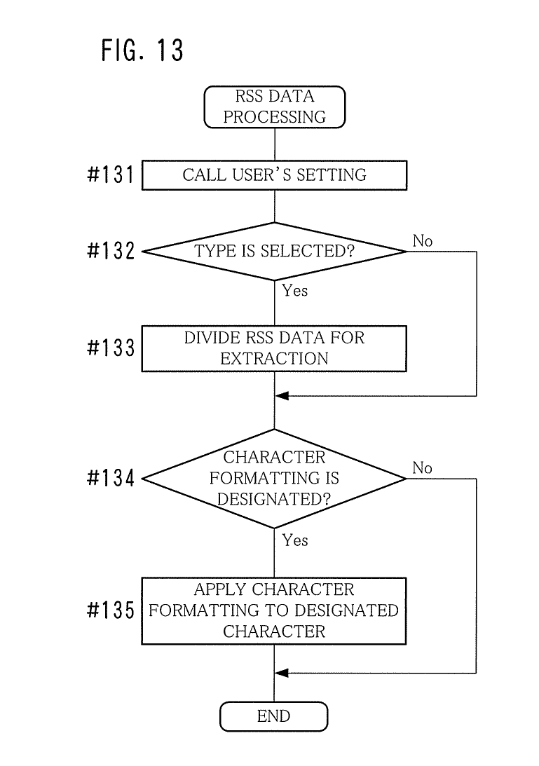

The RSS data is called (#7) and is updated (processed) based on the individual notification setting data 8 (#8). The process procedure is as shown in FIG. 13.

Specifically, referring to FIG. 13, the image forming apparatus 1 calls settings for a selected content and character formatting from the individual notification setting data 8 (#131). If a setting for the selection of a genre (type) is performed (Yes in #132), then, based on the setting details, the RSS data is so updated that only an article of the genre desired by the user X is reserved and articles of the other genres are separated and deleted (#133).

If a setting for character formatting is performed (Yes in #134), then the RSS data is so updated that the character formatting desired by the user X is applied based on the setting details (#135).

Referring back to FIG. 11, in the case where notification methods and destinations different depending on the time are set in the individual notification setting data 8 as illustrated in the individual notification setting data 8h in FIG. 9 (Yes in #10), a notification method or a destination corresponding to the current time is determined to be the notification method or the destination of the RSS data (#11). In contrast, in the case where a notification method and a destination are not changed depending on the time (No in #10), they are determined to be the only notification method and the only destination indicated in the individual notification setting data 8 (#12).

If it is determined that an electronic mail message is used for notification (Yes in #13 in FIG. 12), then an electronic mail message in which the RSS data is described or to which the RSS data is attached is sent to the determined destination (#14). If it is determined that an IM is used for notification (No in #13 and Yes in #15), then a message in which the RSS data is described or to which the RSS data is attached is sent to the determined destination (#16).

If it is determined that a printed material is used for notification (No in #13 and No in #15 in FIG. 12), then the RSS data is associated with the user name of the user X and is stored in the print queue RSS data storing portion 1K3 (#17), so that the user X is informed in the form of a printed material when the user X logs in the image forming apparatus 1 later.

The user X can cause the image forming apparatus 1 to register a plurality of pieces of individual notification setting data 8. In such a case, it is preferable that the user X sends electronic mail messages in each of which an attribute of notification is described to the image forming apparatus 1 in sequence. Every time when an electronic mail message is received, the image forming apparatus 1 performs the processes shown in Steps #2 and #3.

As described earlier with reference to FIGS. 7 and 8, the user can also register individual notification setting data 8 while viewing a screen for setting displayed on the console panel 10j or others.

In the case where a plurality of pieces of individual notification setting data 8 are registered for the user X, the image forming apparatus 1 performs the process for obtaining and notifying RSS data, which is described in Steps #5 to #17, appropriately for each piece of the individual notification setting data 8.

The user X can use his/her terminal 21, terminal 22 or cell phone terminal 3 to receive notification of RSS data, and can confirm the details as shown in FIG. 5. In the case where a plurality of pieces of individual notification setting data 8 are registered, the user X can receive a plurality of notification messages. The user X can use destinations selectively depending on a genre of an article.

When the user X logs in the image forming apparatus 1 (Yes in #18), in the case where RSS data which is associated with the user X and to which an open flag having a value of “0” corresponds is stored in the RSS data storing portion 1K2 or in the case where RSS data associated with the user X is stored in the print queue RSS data storing portion 1K3 (Yes in #19), the image forming apparatus 1 displays a screen for informing that unconfirmed RSS data is present (#20).

Then, when the user designates RSS data and enters printing instructions (Yes in #21), a list of articles indicated in the RSS data is printed on a sheet of paper as shown in FIG. 5 (#22).

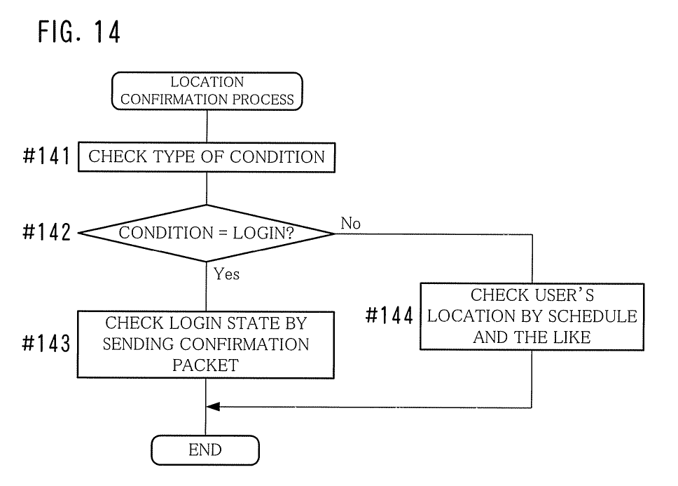

In the case where notification methods and destinations depending on a user state such as a location are set in the individual notification setting data 8 as illustrated in the individual notification setting data 8n in FIG. 10, the image forming apparatus 1 checks whether or not a setting is performed for each state such as the location in Step #9 of FIG. 11. If such a setting is performed (Yes in #10), then, before the process of Step #11, the location of the user X or the like is confirmed according to the procedure shown in FIG. 14.

A check is made to the kind of a condition shown in “location condition” of the individual notification setting data 8 (#141). If the condition is a condition regarding whether or not the user is logging in (Yes in #142), then it is checked whether or not the user X logs in by sending a packet for confirmation to a terminal such as the terminal 21 (#143). If the condition is a condition regarding the current location (No in #142), then the current location of the user X is checked by making an inquiry to a system for managing a schedule or the like (#144).

Among settings for notification methods and destinations shown in the individual notification setting data 8, the image forming apparatus 1 determines a notification method or a destination corresponding to the current state of the user X to be the notification method or the destination of the RSS data (#11).

In parallel with the process for the user X as described above, the image forming apparatus 1 performs a process for users other than the user X in a similar manner.

According to this embodiment, a user can set an attribute of notification for each piece of RSS data desired by the user. Specifically, the user can set a notification method, a destination, a genre of an article, character formatting, and others with respect to the notification. This enables the user to obtain RSS data conveniently compared to conventional systems.

In this embodiment, a description is provided of the case where RSS data is the target of notification to a user. The present invention, however, can apply to the case where the target of notification is data in different formats.

As described above, since RSS data is notified at regular intervals, notification may be performed based on the same individual notification setting data 8. This causes a situation in which the details of RSS data to be notified from now are identical to the details of RSS data notified before. In such a case, an updated part or a newly added part may be notified instead of notifying the whole RSS data.

In this embodiment, a description is provided of an example (see FIGS. 9 and 10) in which a notification method or a destination is changed depending on a time condition or a condition of a user state such as a location. Instead, however, a notification method or a destination may be changed depending on other conditions.

For example, such a condition may be the size of RSS data to be notified. In such a case, if the size of RSS data is equal to or greater than a predetermined size, then the RSS data may be sent to an electronic mail address of the terminal 21. If the size is smaller than the predetermined size, then the RSS data may be sent to an electronic mail address of the cell phone terminal 3. Alternatively, such a condition may be the number of articles of RSS data to be notified. In such a case, if the number of articles is equal to or greater than a predetermined number, then the RSS data may be sent to an electronic mail address of the terminal 21. If the number of articles is smaller than the predetermined number, then the RSS data may be sent to an electronic mail address of the cell phone terminal 3.

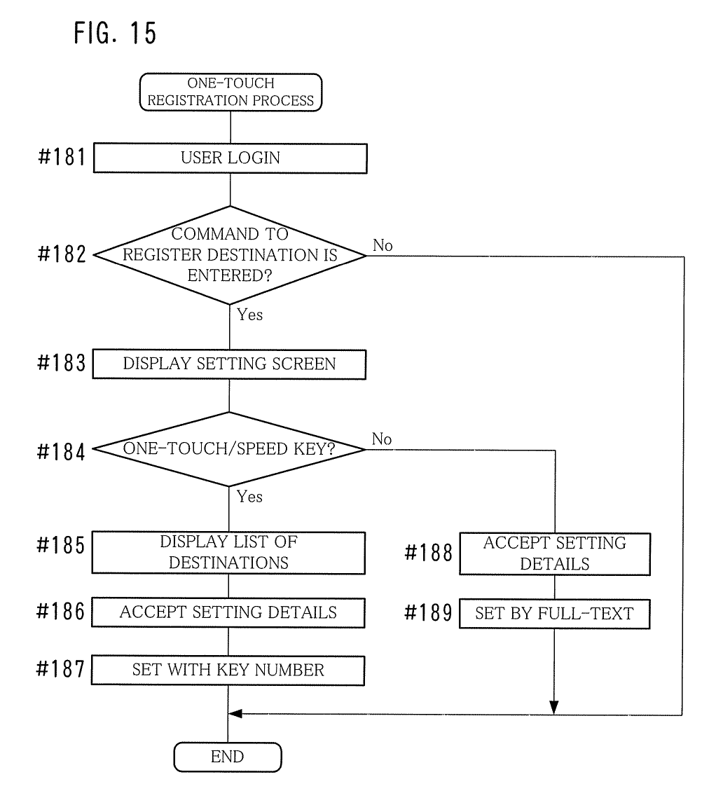

FIG. 15 is a flowchart showing an example of a flow of an one-touch registration process.

In this embodiment, when a user registers new individual notification setting data 8, he/she designates a destination by entering characters of a character string of the destination one by one. Instead, another configuration is possible in which a destination is designated by selection from among electronic mail addresses registered in an address book provided in the image forming apparatus 1 or registered in a database of a user profile. In such a case, the image forming apparatus 1 performs a process, for example, according to the procedure shown in FIG. 15.

When a user logs in the image forming apparatus 1 (#181 in FIG. 15) and enters a command to register an attribute of notification (Yes in #182), the image forming apparatus 1 displays the screen for setting as shown in FIG. 8 (#183).

Upon the press of the “one-touch/speed” button (Yes in #184), the image forming apparatus 1 displays a list of electronic mail addresses registered in an address book provided therein or registered in a database of a user profile (#185). The image forming apparatus 1 may display a list of electronic mail addresses registered in an address book managed by, for example, a Lightweight Directory Access Protocol (LDAP) server within the intranet 5. The image forming apparatus 1 may select and display an electronic mail address of a user himself/herself logging therein instead of displaying all electronic mail addresses.

A user can select an electronic mail address to be designated as the destination from among the list by touching the electronic mail address, as with the selection of speed dialing.

When the user selects and designates any electronic mail address and also designates the other details of an attribute, the image forming apparatus 1 accepts the details thus designated (#186) and generates individual notification setting data 8 indicating the details for registration (#187). Instead of showing the selected electronic mail address without any change in individual notification setting data 8, a key number for identifying the selected electronic mail address may be shown therein. Then, upon the transmission of RSS data, the key number may be used as a search key and a character string of the electronic mail address may be searched from the address book.

In contrast, in the case where the “one-touch/speed” button is not pressed (No in #184), the image forming apparatus 1 generates and registers individual notification setting data 8 including an electronic mail address that the user enters letter-by-letter for designation (#188 and #189).

Further, the user can also delete individual notification setting data 8 that is already registered on the screen for setting shown in FIG. 8.

When the user enters a predetermined command, the image forming apparatus 1 displays a list of individual notification setting data 8 of the user. When the user selects individual notification setting data 8 to be deleted from among the list, the image forming apparatus 1 displays the screen for setting shown in FIG. 8 with the details of the individual notification setting data 8 being designated. Then, when the user presses a “delete” button, the image forming apparatus 1 deletes the individual notification setting data 8 from destination setting data 7 of the user.

In the embodiments described above, an MFP is used as the image forming apparatus 1. Instead, however, the image forming apparatus 1 can be a personal computer, a server machine, or the like. A system in which these devices are combined with a printer may be used as the image forming apparatus 1. Further, a PHS terminal or a Personal Digital Assistant (PDA) may be used in lieu of the cell phone terminal 3.

In the embodiments described above, the overall configuration of the image forming apparatus 1, the terminal 21, the terminal 22, the cell phone terminal 3, the Web server 4 and the intranet 5, the configurations of various portions thereof, the details of processing, the processing order, the structure of the destination setting data 7, the structure of the individual notification setting data 8, the notification method, and the like may be changed as needed, in accordance with the subject matter of the present invention.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A provision information notification apparatus for obtaining one or more pieces of provision information designated by a user to notify the user, each of the pieces of the provision information being information provided by a server, the apparatus comprising:
a notification attribute storing portion that stores, for each of the pieces of the provision information, a notification attribute that is an attribute relating to notification of the piece of the provision information, the notification attribute including a destination and a notification method that are designated by the user;
an obtaining portion that obtains the piece of the provision information via a communication line; and
a notification portion that performs, every time when the piece of the provision information is obtained, a process for notifying the user of the piece of the provision information, the process being performed by sending the piece of the provision information to the destination included in the notification attribute of the piece of the provision information by the notification method included in the notification attribute of the piece of the provision information.

2. The provision information notification apparatus according to claim 1, wherein
the notification attribute of the piece of the provision information includes a type of character formatting to be applied to a character in the piece of the provision information, and
the notification portion changes the piece of the provision information in accordance with the type included in the notification attribute of the piece of the provision information and sends the changed piece of the provision information.

3. The provision information notification apparatus according to claim 1, wherein
the notification attribute of the piece of the provision information includes a plurality of the destinations and a plurality of the notification methods and each of the destinations is a destination depending on one of periods and each of the notification methods is a notification method depending on one of the periods, and
the notification portion gives notice of the piece of the provision information by sending the piece of the provision information to the destination depending on the period corresponding to time when the piece of the provision information is notified by the notification method depending on the period corresponding to the time.

4. The provision information notification apparatus according to claim 1, further comprising
a detection portion that detects a current state of the user,
wherein
the notification attribute of the piece of the provision information includes a plurality of the destinations and a plurality of the notification methods and each of the destinations is a destination depending on one of states and each of the notification methods is a notification method depending on one of the states, and
the notification portion gives notice of the piece of the provision information by sending the piece of the provision information to the destination depending on the current state of the user detected by the detection portion by the notification method depending on the current state of the user detected by the detection portion.

5. The provision information notification apparatus according to claim 1, further comprising
a printing portion that prints the piece of the provision information,
wherein
when the notification method included in the notification attribute of the piece of the provision information is a method of electronic mail transmission, the notification portion gives notice of the piece of the provision information by sending an electronic mail message in which the piece of the provision information is described or to which the piece of the provision information is attached,
when the notification method included in the notification attribute of the piece of the provision information is a method of message transmission with an instant messenger, the notification portion gives notice of the piece of the provision information by sending a message in which the piece of the provision information is described or to which the piece of the provision information is attached, and
when the notification method included in the notification attribute of the piece of the provision information is a method of provision of a printed material, the notification portion gives notice of the piece of the provision information by causing the printing portion to perform a process for printing the piece of the provision information on a sheet of paper when the user logs in the provision information notification apparatus, instead of by sending the piece of the provision information.

6. The provision information notification apparatus according to claim 1, wherein the piece of the provision information is described in an RSS format.

7. The provision information notification apparatus according to claim 6, further comprising
a storage location storing portion that stores, for each of the pieces of the provision information, a location on a network where RSS data describing the piece of the provision information is stored,
wherein
the obtaining portion obtains, at each predetermined timing, the RSS data from the location where the RSS data is stored, and
when a plurality of pieces of the RSS data have been obtained from the same location at different timings, the notification portion gives notice of the piece of the provision information in which a piece of provision information described in RSS data obtained before is removed from another piece of provision information described in RSS data obtained recently.

8. A provision information notification method comprising:
a step of obtaining one or more pieces of provision information designated by a user via a communication line, each of the pieces of the provision information being provided by a server, possessing a notification attribute that includes a destination and a notification method of the piece of the provision information and is stored in a storage device; and
a step of transmitting, every time when the piece of the provision information is obtained, the piece of the provision information to the destination included in the notification attribute of the piece of the provision information by the notification method included in the notification attribute of the piece of the provision information.

9. The provision information notification method according to claim 8, wherein
the notification attribute of the piece of the provision information includes a type of character formatting to be applied to a character in the piece of the provision information, and
in the transmission step, the piece of the provision information is changed in accordance with the type included in the notification attribute of the piece of the provision information and the changed piece of the provision information is transmitted.

10. The provision information notification method according to claim 8, wherein
the notification attribute of the piece of the provision information includes a plurality of the destinations and a plurality of the notification methods and each of the destinations is a destination depending on one of periods and each of the notification methods is a notification method depending on one of the periods, and
in the transmission step, the piece of the provision information is transmitted to the destination depending on the period corresponding to time when the piece of the provision information is notified by the notification method depending on the period corresponding to the time.

11. The provision information notification method according to claim 8, further comprising
a step of detecting a current state of the user,
wherein
the notification attribute of the piece of the provision information includes a plurality of the destinations and a plurality of the notification methods and each of the destinations is a destination depending on one of states and each of the notification methods is a notification method depending on one of the states, and
in the transmission step, the piece of the provision information is transmitted to the destination depending on the current state of the user detected in the detection step by the notification method depending on the current state of the user detected in the detection step.

12. The provision information notification method according to claim 8,
wherein in the transmission step,
when the notification method included in the notification attribute of the piece of the provision information is a method of electronic mail transmission, an electronic mail message in which the piece of the provision information is described or to which the piece of the provision information is attached is transmitted,
when the notification method included in the notification attribute of the piece of the provision information is a method of message transmission with an instant messenger, a message in which the piece of the provision information is described or to which the piece of the provision information is attached is transmitted, and
when the notification method included in the notification attribute of the piece of the provision information is a method of provision of a printed material, a printing portion is caused to perform a process for printing the piece of the provision information on a sheet of paper when the user logs in a provision information notification apparatus, instead of transmitting the piece of the provision information.

13. The provision information notification method according to claim 8, wherein the piece of the provision information is described in an RSS format.

14. The provision information notification method according to claim 13,
wherein if there is provided a storage location storing portion that stores, for each of the pieces of the provision information, a location on a network where RSS data describing the piece of the provision information is stored, in the obtaining step, the RSS data is obtained, at each predetermined timing, from the location where the RSS data is stored, and
in the transmission step, when a plurality of pieces of the RSS data have been obtained from the same location at different timings, the piece of the provision information in which a piece of provision information described in RSS data obtained before is removed from another piece of provision information described in RSS data obtained recently is transmitted.

15. A software program stored on a computer readable medium for causing a computer to execute processing comprising:
obtaining one or more pieces of provision information designated by a user via a communication line, each of the pieces of the provision information being provided by a server, possessing a notification attribute that includes a destination and a notification method of the piece of the provision information and is stored in a storage device; and
transmitting, every time when the piece of the provision information is obtained, the piece of the provision information to the destination included in the notification attribute of the piece of the provision information by the notification method included in the notification attribute of the piece of the provision information.
